(19) United States
(12) Patent Application Publication
(10) Pub. No.: US 2026/0081641 A1
(43) Pub. Date: Mar. 19, 2026

(54) SUPPLEMENTARY UPLINK FOR ENABLING HIGH POWER CLASS FOR FREQUENCY DIVISION DUPLEXING

(71) Applicant: Skyworks Solutions, Inc., Irvine, CA (US)

(72) Inventors: David Richard Pehlke, Westlake Village, CA (US); Laurent Noel, Laval (CA); Dominique Michel Yves Brunel, Antibes (FR)

(21) Appl. No.: 19/330,128

(22) Filed: Sep. 16, 2025

Related U.S. Application Data
(60) Provisional application No. 63/695,598, filed on Sep. 17, 2024.

(51) Int. Cl. H04B 1/44; H04B 1/00; H04L 5/14; H04W 28/20

(52) U.S. Cl. CPC H04B 1/44; H04B 1/0057; H04L 5/14; H04W 28/20

(57) ABSTRACT

Techniques for supplementary uplink (SUL) to enable high power class for frequency division duplexing (FDD) are disclosed. In certain embodiments, a mobile device for a cellular network includes a front-end system that includes a first duplexer for a first frequency band that operates using FDD and a second duplexer for a second frequency band that operates using FDD. Additionally, the mobile device provides high power class for FDD by transmitting a transmit signal over an uplink frequency range of the first frequency band and receiving a receive signal over a downlink frequency range of the second frequency band. The first frequency band and the second frequency band can have a large frequency offset, for instance, at least five times the channel bandwidth of the transmit signal.

### CROSS-REFERENCE TO RELATED APPLICATIONS

This application claims the benefit of priority under 35 U.S.C. § 119 of U.S. Provisional Patent Application No. 63/695,598, filed Sep. 17, 2024 and titled “SUPPLEMENTARY UPLINK FOR ENABLING HIGH POWER CLASS FOR FREQUENCY DIVISION DUPLEXING,” which is herein incorporated by reference in its entirety.

### BACKGROUND

### Field

Embodiments of the invention relate to electronic systems, and in particular, to radio frequency electronics.

### Description of Related Technology

Radio frequency (RF) communication systems can be used for transmitting and/or receiving signals of various frequencies. Examples of RF communication systems include, but are not limited to, mobile phones, tablets, base stations, network access points, customer-premises equipment (CPE), laptops, and wearable electronics.

### SUMMARY

In certain embodiments, the present disclosure relates to a mobile device. The mobile device includes an antenna, and a front-end system coupled to the antenna. The front-end system includes a first duplexer for a first frequency band that operates using frequency division duplexing, a second duplexer for a second frequency band that operates using frequency division duplexing, a first power amplifier coupled to a transmit section of the first duplexer, a first low noise amplifier coupled to a receive section of the first duplexer, and a second low noise amplifier coupled to a receive section of the second duplexer. The mobile device provides supplementary uplink for frequency division duplexing by transmitting a transmit signal from the first power amplifier through the first duplexer and receiving a receive signal at the second low noise amplifier through the second duplexer.

In various embodiments, the first low noise amplifier is turned off when the mobile device is providing supplementary uplink.

In several embodiments, the transmit signal is associated with power class 2.

In some embodiments, the first frequency band is in a low band frequency range. According to a number of embodiments, the second frequency band is in a mid band frequency range, a high band frequency range, an ultrahigh band frequency range, or also in the low band frequency range.

In various embodiments, the first frequency band is offset in frequency from the second frequency band by at least five times a channel bandwidth of the transmit signal.

In some embodiments, the first frequency band is band 28 and the second frequency band is band 3.

In several embodiments, the first frequency band is band 5 and the second frequency band is band 1.

In some embodiments, the front-end system further includes a second power amplifier coupled to a transmit section of the second duplexer. According to a number of embodiments, the second power amplifier is turned off when the mobile device is providing supplementary uplink. According to various embodiments, the mobile device further includes a transmit/receive switch, a third power amplifier having an output coupled to the transmit/receive switch, and a third low noise amplifier having an input coupled to the transmit/receive switch, the third power amplifier active for normal uplink and turned off for supplementary uplink. In accordance with a number of embodiments, the mobile device transitions from normal uplink to supplementary uplink at a cell edge. According to some embodiments, the mobile device transitions from power class 3 to power class 2 at the cell edge, the transmit signal being associated with power class 2.

In various embodiments, the mobile device further includes a transceiver configured to provide the transmit signal to the front-end system.

In certain embodiments, a method of supplemental uplink in a mobile device is disclosed. The method includes providing duplexing for a first frequency band operating with frequency division duplexing using a first duplexer of a front-end system, the first duplexer having a transmit section coupled to a first power amplifier of the front-end system and a receive section coupled to a first low noise amplifier of the front-end system. The method further includes providing duplexing for a second frequency band operating with frequency division duplexing using a second duplexer of the front-end system, the second duplexer having a receive section coupled to a second low noise amplifier of the front-end system. The method further includes providing supplementary uplink for frequency division duplexing by transmitting a transmit signal from the first power amplifier through the first duplexer and receiving a receive signal at the second low noise amplifier through the second duplexer.

In various embodiments, the method further includes turning off the first low noise amplifier when providing supplementary uplink.

In several embodiments, the transmit signal is associated with power class 2.

In some embodiments, the first frequency band is in a low band frequency range. According to a number of embodiments, the second frequency band is in a mid band frequency range, the second frequency band is in a high band frequency range, the second frequency band is in an ultrahigh band frequency range, and the second frequency band is in the low band frequency range.

In various embodiments, the first frequency band is offset in frequency from the second frequency band by at least five times a channel bandwidth of the transmit signal.

In several embodiments, the first frequency band is band 28 and the second frequency band is band 3.

In some embodiments, the first frequency band is band 5 and the second frequency band is band 1.

In various embodiment, a second power amplifier is coupled to a transmit section of the second duplexer, and the method further includes turning off the second power amplifier when providing supplementary uplink.

In some embodiments, the front-end system further includes a transmit/receive switch, a third power amplifier having an output coupled to the transmit/receive switch, and a third low noise amplifier having an input coupled to the transmit/receive switch, the method further comprising turning on the third power amplifier active for normal uplink and turning off the third power amplifier for supplementary uplink. According to a number of embodiments, the method further includes transitioning from normal uplink to supplementary uplink at a cell edge. In accordance with several embodiments, the method further includes transitioning from power class 3 to power class 2 at the cell edge, the transmit signal being associated with power class 2.

In various embodiments, the method further includes providing the transmit signal to the front-end system from a transceiver.

In some embodiments, a front-end system for a mobile device is disclosed. The front-end system includes a first duplexer for a first frequency band that operates using frequency division duplexing, a second duplexer for a second frequency band that operates using frequency division duplexing, a first power amplifier coupled to a transmit section of the first duplexer, a first low noise amplifier coupled to a receive section of the first duplexer, and a second low noise amplifier coupled to a receive section of the second duplexer, the front-end system providing supplementary uplink for frequency division duplexing by transmitting a transmit signal from the first power amplifier through the first duplexer and receiving a receive signal at the second low noise amplifier through the second duplexer.

In various embodiments, the first low noise amplifier is turned off during supplementary uplink.

In some embodiments, the transmit signal is associated with power class 2.

In several embodiments, the first frequency band is in a low band frequency range. According to a number of embodiments, the second frequency band is in a mid band frequency range, a high band frequency range, an ultrahigh band frequency range, or also in the low band frequency range.

In various embodiments, the first frequency band is offset in frequency from the second frequency band by at least five times a channel bandwidth of the transmit signal. According to a number of embodiments, the first frequency band is band 28 and the second frequency band is band 3. In accordance with several embodiments, the first frequency band is band 5 and the second frequency band is band 1.

In some embodiments, the front-end system further includes a second power amplifier coupled to a transmit section of the second duplexer. According to a number of embodiments, the second power amplifier is turned off when the mobile device is providing supplementary uplink. In accordance with several embodiments, the front-end system further includes a transmit/receive switch, a third power amplifier having an output coupled to the transmit/receive switch, and a third low noise amplifier having an input coupled to the transmit/receive switch, the third power amplifier active for normal uplink and turned off for supplementary uplink. According to various embodiments, the front-end system transitions from normal uplink to supplementary uplink at a cell edge. In accordance with a number of embodiments, the front-end system transitions from power class 3 to power class 2 at the cell edge, the transmit signal being associated with power class 2.

### BRIEF DESCRIPTION OF THE DRAWINGS

FIG. 1 is a schematic diagram of one example of a communication network.

FIG. 2A is a schematic diagram of one example of a communication link using carrier aggregation.

FIG. 2B illustrates various examples of uplink carrier aggregation for the communication link of FIG. 2A.

FIG. 2C illustrates various examples of downlink carrier aggregation for the communication link of FIG. 2A.

FIG. 3A is a schematic diagram of one example of a downlink channel using multi-input and multi-output (MIMO) communications.

FIG. 3B is schematic diagram of one example of an uplink channel using MIMO communications.

FIG. 3C is schematic diagram of another example of an uplink channel using MIMO communications.

FIG. 4 is a schematic diagram of an example dual connectivity network topology.

FIG. 5A is a schematic diagram of one example of a communication system that operates with beamforming.

FIG. 5B is a schematic diagram of one example of beamforming to provide a transmit beam.

FIG. 5C is a schematic diagram of one example of beamforming to provide a receive beam.

FIG. 6A is a schematic diagram of one embodiment of a communication network using supplementary uplink (SUL).

FIG. 6B is a schematic diagram of another embodiment of a communication network using SUL.

FIG. 6C is a schematic diagram of another embodiment of a communication network using SUL.

FIG. 7A is a schematic diagram of one embodiment of a mobile device providing SUL to support high power class for frequency division duplexing (FDD).

FIG. 7B is a schematic diagram of another embodiment of a front-end system for a mobile device providing SUL to support high power class for FDD.

FIG. 8 is a schematic diagram of another embodiment of a mobile device.

### DETAILED DESCRIPTION OF EMBODIMENTS

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The International Telecommunication Union (ITU) is a specialized agency of the United Nations (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society, India (TSDSI).

Working within the scope of the ITU, 3GPP develops and maintains technical specifications for a variety of mobile communication technologies, including, for example, second generation (2G) technology (for instance, Global System for Mobile Communications (GSM) and Enhanced Data Rates for GSM Evolution (EDGE)), third generation (3G) technology (for instance, Universal Mobile Telecommunications System (UMTS) and High Speed Packet Access (HSPA)), and fourth generation (4G) technology (for instance, Long Term Evolution (LTE) and LTE-Advanced).

The technical specifications controlled by 3GPP can be expanded and revised by specification releases, which can span multiple years and specify a breadth of new features and evolutions.

In one example, 3GPP introduced carrier aggregation (CA) for LTE in Release 10. Although initially introduced with two downlink carriers, 3GPP expanded carrier aggregation in Release 14 to include up to five downlink carriers and up to three uplink carriers. Other examples of new features and evolutions provided by 3GPP releases include, but are not limited to, License Assisted Access (LAA), enhanced LAA (eLAA), Narrowband Internet of things (NB-IOT), Vehicle-to-Everything (V2X), and High Power User Equipment (HPUE).

3GPP introduced Phase 1 of fifth generation (5G) technology in Release 15 and introduced Phase 2 of 5G technology in Release 16. Subsequent 3GPP releases further evolve and expand 5G technology. 5G technology is also referred to herein as 5G New Radio (NR). 3GPP has also introduced various proposals for sixth generation (6G) technology.

5G and/or 6G supports or plans to support a variety of features, such as communications over millimeter wave spectrum, beamforming capability, high spectral efficiency waveforms, low latency communications, multiple radio numerology, and/or non-orthogonal multiple access (NOMA). Although such RF functionalities offer flexibility to networks and enhance user data rates, supporting such features can pose a number of technical challenges.

The teachings herein are applicable to a wide variety of communication systems, including, but not limited to, communication systems using advanced cellular technologies, such as LTE-Advanced, LTE-Advanced Pro, 5G and/or 6G.

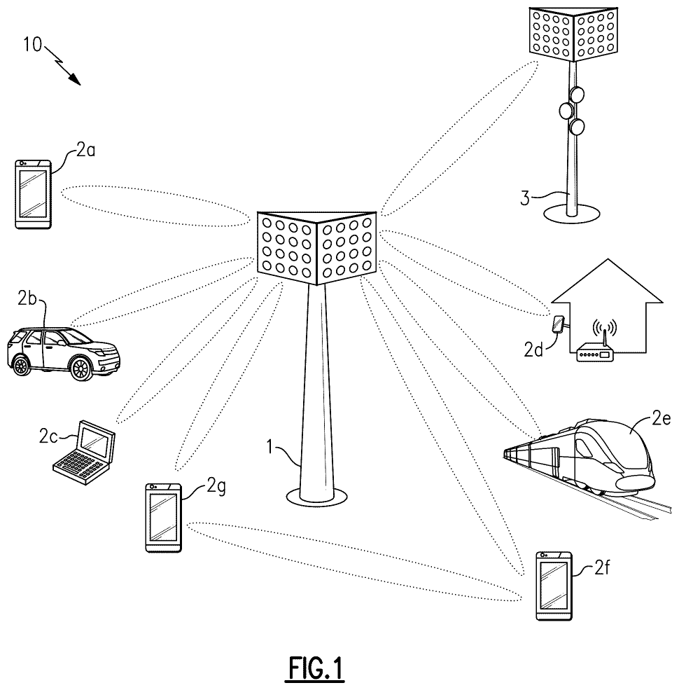

FIG. 1 is a schematic diagram of one example of a communication network 10. The communication network 10 includes a macro cell base station 1, a small cell base station 3, and various examples of user equipment (UE), including a first mobile device 2a, a wireless-connected car 2b, a laptop 2c, a stationary wireless device 2d, a wireless-connected train 2e, a second mobile device 2f, and a third mobile device 2g.

Although specific examples of base stations and user equipment are illustrated in FIG. 1, a communication network can include base stations and user equipment of a wide variety of types and/or numbers.

For instance, in the example shown, the communication network 10 includes the macro cell base station 1 and the small cell base station 3. The small cell base station 3 can operate with relatively lower power, shorter range, and/or with fewer concurrent users relative to the macro cell base station 1. The small cell base station 3 can also be referred to as a femtocell, a picocell, or a microcell. Although the communication network 10 is illustrated as including two base stations, the communication network 10 can be implemented to include more or fewer base stations and/or base stations of other types.

Although various examples of user equipment are shown, the teachings herein are applicable to a wide variety of user equipment (UE), including, but not limited to, mobile phones, tablets, laptops, IoT devices, wearable electronics, customer premises equipment (CPE), wireless-connected vehicles, wireless relays, and/or a wide variety of other communication devices. Furthermore, user equipment includes not only currently available communication devices that operate in a cellular network, but also subsequently developed communication devices that will be readily implementable with the inventive systems, processes, methods, and devices as described and claimed herein.

The illustrated communication network 10 of FIG. 1 supports communications using a variety of cellular technologies, including, for example, 4G LTE, 5G NR, and/or 6G. In certain implementations, the communication network 10 is further adapted to provide a wireless local area network (WLAN), such as WiFi. Although various examples of communication technologies have been provided, the communication network 10 can be adapted to support a wide variety of communication technologies.

Various communication links of the communication network 10 have been depicted in FIG. 1. The communication links can be duplexed in a wide variety of ways, including, for example, using frequency division duplexing (FDD) and/or time division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

In certain implementations, user equipment can communicate with a base station using one or more of 4G LTE, 5G NR, 6G, and WiFi technologies. In certain implementations, enhanced license assisted access (eLAA) is used to aggregate one or more licensed frequency carriers (for instance, licensed 4G LTE, 5G NR, and/or 6G frequencies), with one or more unlicensed carriers (for instance, unlicensed WiFi frequencies).

As shown in FIG. 1, the communication links include not only communication links between UE and base stations, but also UE to UE communications and base station to base station communications. For example, the communication network 10 can be implemented to support self-fronthaul and/or self-backhaul.

In certain implementations, a base station and/or user equipment communicates using beamforming. For example, beamforming can be used to focus signal strength to overcome path losses, such as high loss associated with communicating over high signal frequencies. In certain embodiments, user equipment, such as one or more mobile phones, communicate using beamforming on millimeter wave frequency bands in the range of 30 GHz to 300 GHz and/or upper centimeter wave frequencies in the range of 6 GHz to 30 GHz, or more particularly, 24 GHz to 30 GHz.

The depicted communication links can operate over a wide variety of frequencies. For example, cellular user equipment can communicate using beamforming and/or other techniques over a wide range of frequencies, including, for example, FR1 (400 MHz to 7 GHz), FR2 (24 GHz to 71 GHZ) (which includes FR2-1 (24 GHz to 52 GHz) and FR2-2 (52 GHz to 71 GHz)), and/or FR3 (7 GHz to 24 GHz).

Different users of the communication network 10 can share available network resources, such as available frequency spectrum, in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA) and orthogonal FDMA (OFDMA). OFDMA is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user a unique code, space-divisional multiple access (SDMA) in which beamforming is used to provide shared access by spatial division, and non-orthogonal multiple access (NOMA) in which the power domain is used for multiple access. For example, NOMA can be used to serve multiple users at the same frequency, time, and/or code, but with different power levels.

Enhanced mobile broadband (eMBB) refers to technology for growing system capacity of LTE networks. For example, eMBB can refer to communications with a peak data rate of at least 10 Gbps and a minimum of 100 Mbps for each user. Ultra-reliable low latency communications (uRLLC) refers to technology for communication with very low latency, for instance, less than 2 milliseconds. uRLLC can be used for mission-critical communications such as for autonomous driving and/or remote surgery applications. Massive machine-type communications (mMTC) refers to low cost and low data rate communications associated with wireless connections to everyday objects, such as those associated with Internet of Things (IoT) applications.

The communication network 10 of FIG. 1 can be used to support a wide variety of advanced communication features, including, but not limited to, cMBB, uRLLC, and/or mMTC.

Typically, wireless communication frequencies can be divided into a low frequency band range (e.g., approximately 698 MHz-approximately 960 MHz, LB), a middle frequency band range (e.g., approximately 1427 MHz-approximately 2200 MHz, MB), a high frequency band range (e.g., approximately 2300 MHz-approximately 2690 MHz, HB) and an ultrahigh frequency band range (e.g., approximately 3400 MHZ-approximately 3600 MHZ, UHB).

Each frequency band range includes multiple cellular frequency bands. For instance, some examples of LTE FDD frequency bands are shown in Table 1 below. As shown in Table 1, HB for FDD includes, but is not limited to, Band 30 (B30), Band 7 (B7), etc. Likewise, MB includes, but is not limited to band 74 (B74), Band 65 (B65), etc. Thus, each frequency band range includes multiple cellular bands. Further, the cellular bands of one radio access technology (for instance, 4G or LTE) can overlap with those of another RAT (for instance, 5G). Although examples of LTE FDD bands are shown, various RATs have FDD and/or TDD bands covering various frequency ranges.

TABLE 1

| | | Tx Frequency | Rx Frequency |
|---|---|---|---|
| Band | Mode | Range (MHz) | Range (MHz) |
| B1 | FDD | 1,920-1,980 | 2,110-2,170 |
| B2 | FDD | 1,850-1,910 | 1,930-1,990 |
| B3 | FDD | 1,710-1,785 | 1,805-1,880 |
| B4 | FDD | 1,710-1,755 | 2,110-2,155 |
| B5 | FDD | 824-849 | 869-894 |
| B6 | FDD | 830-840 | 875-885 |
| B7 | FDD | 2,500-2,570 | 2,620-2,690 |
| B8 | FDD | 880-915 | 925-960 |
| B9 | FDD | 1,749.9-1,784.9 | 1,844.9-1,879.9 |
| B10 | FDD | 1,710-1,770 | 2,110-2,170 |
| B11 | FDD | 1,427.9-1,447.9 | 1,475.9-1,495.9 |
| B12 | FDD | 699-716 | 729-746 |
| B13 | FDD | 777-787 | 746-756 |
| B14 | FDD | 788-798 | 758-768 |
| B15 | FDD | 1,900-1,920 | 2,600-2,620 |
| B16 | FDD | 2,010-2,025 | 2,585-2,600 |
| B17 | FDD | 704-716 | 734-746 |
| B18 | FDD | 815-830 | 860-875 |
| B19 | FDD | 830-845 | 875-890 |
| B20 | FDD | 832-862 | 791-821 |
| B21 | FDD | 1,447.9-1,462.9 | 1,495.9-1,510.9 |
| B22 | FDD | 3,410-3,490 | 3,510-3,590 |
| B23 | FDD | 2,000-2,020 | 2,180-2,200 |
| B24 | FDD | 1,626.5-1,660.5 | 1,525-1,559 |
| B25 | FDD | 1,850-1,915 | 1,930-1,995 |
| B26 | FDD | 814-849 | 859-894 |
| B27 | FDD | 807-824 | 852-869 |
| B28 | FDD | 703-748 | 758-803 |
| B30 | FDD | 2,305-2,315 | 2,350-2,360 |
| B31 | FDD | 452.5-457.5 | 462.5-467.5 |
| B65 | FDD | 1,920-2,010 | 2,110-2,200 |
| B66 | FDD | 1,710-1,780 | 2,110-2,200 |
| B68 | FDD | 698-728 | 753-783 |
| B70 | FDD | 1,695-1,710 | 1,995-2,020 |
| B71 | FDD | 663-698 | 617-652 |
| B72 | FDD | 451-456 | 461-466 |
| B73 | FDD | 450-455 | 460-465 |
| B74 | FDD | 1,427-1,470 | 1,475-1,518 |
| B85 | FDD | 698-716 | 728-746 |
| B87 | FDD | 410-415 | 420-425 |
| B88 | FDD | 412-417 | 422-427 |
| B103 | FDD | 787-788 | 757-758 |
| B106 | FDD | 896-901 | 935-940 |

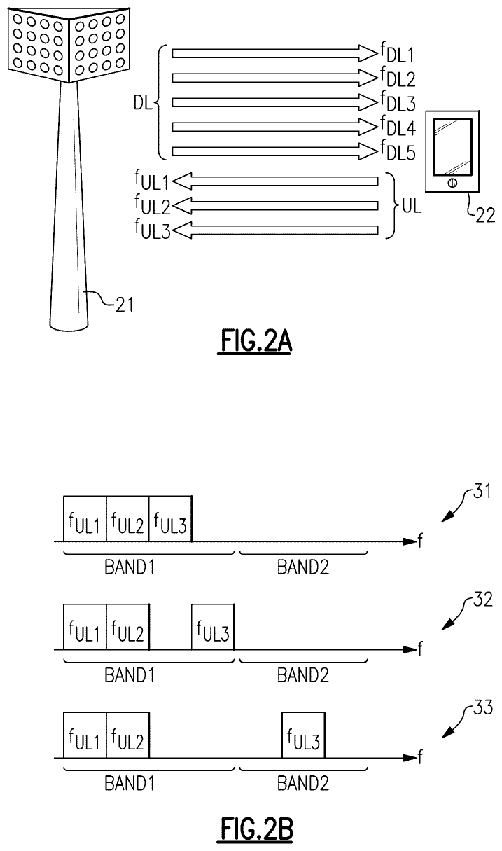

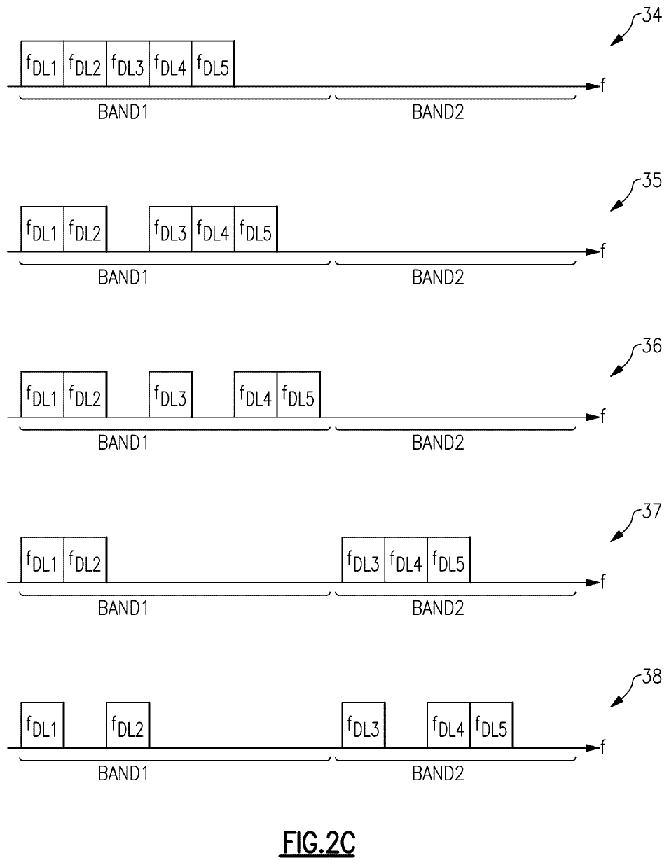

FIG. 2A is a schematic diagram of one example of a communication link using carrier aggregation. Carrier aggregation can be used to widen bandwidth of the communication link by supporting communications over multiple frequency carriers, thereby increasing user data rates and enhancing network capacity by utilizing fragmented spectrum allocations.

In the illustrated example, the communication link is provided between a base station 21 and a mobile device 22. As shown in FIG. 2A, the communications link includes a downlink channel used for RF communications from the base station 21 to the mobile device 22, and an uplink channel used for RF communications from the mobile device 22 to the base station 21.

Although FIG. 2A illustrates carrier aggregation in the context of FDD communications, carrier aggregation can also be used for TDD communications.

In certain implementations, a communication link can provide asymmetrical data rates for a downlink channel and an uplink channel. For example, a communication link can be used to support a relatively high downlink data rate to enable high speed streaming of multimedia content to a mobile device, while providing a relatively slower data rate for uploading data from the mobile device to the cloud.

In the illustrated example, the base station 21 and the mobile device 22 communicate via carrier aggregation, which can be used to selectively increase bandwidth of the communication link. Carrier aggregation includes contiguous aggregation, in which contiguous carriers within the same operating frequency band are aggregated. Carrier aggregation can also be non-contiguous and can include carriers separated in frequency within a common band or in different bands.

In the example shown in FIG. 2A, the uplink channel includes three aggregated component carriers f_{UL1}, f_{UL2}, and f_{UL3}. Additionally, the downlink channel includes five aggregated component carriers f_{DL1}, f_{DL2}, f_{DL3}, f_{DL4}, and f_{DL5}. Although one example of component carrier aggregation is shown, more or fewer carriers can be aggregated for uplink and/or downlink. Moreover, a number of aggregated carriers can be varied over time to achieve desired uplink and downlink data rates.

For example, a number of aggregated carriers for uplink and/or downlink communications with respect to a particular mobile device can change over time. For example, the number of aggregated carriers can change as the device moves through the communication network and/or as network usage changes over time.

FIG. 2B illustrates various examples of uplink carrier aggregation for the communication link of FIG. 2A. FIG. 2B includes a first carrier aggregation scenario 31, a second carrier aggregation scenario 32, and a third carrier aggregation scenario 33, which schematically depict three types of carrier aggregation.

The carrier aggregation scenarios 31-33 illustrate different spectrum allocations for a first component carrier f_{UL1}, a second component carrier f_{UL2}, and a third component carrier f_{UL3}. Although FIG. 2B is illustrated in the context of aggregating three component carriers, carrier aggregation can be used to aggregate more or fewer carriers. Moreover, although illustrated in the context of uplink, the aggregation scenarios are also applicable to downlink.

The first carrier aggregation scenario 31 illustrates intra-band contiguous carrier aggregation, in which component carriers that are adjacent in frequency and in a common frequency band are aggregated. For example, the first carrier aggregation scenario 31 depicts aggregation of component carriers f_{UL1}, f_{UL2}, and f_{UL3} that are contiguous and located within a first frequency band BAND1.

With continuing reference to FIG. 2B, the second carrier aggregation scenario 32 illustrates intra-band non-continuous carrier aggregation, in which two or more components carriers that are non-adjacent in frequency and within a common frequency band are aggregated. For example, the second carrier aggregation scenario 32 depicts aggregation of component carriers f_{UL1}, f_{UL2}, and f_{UL3} that are non-contiguous, but located within a first frequency band BAND1.

The third carrier aggregation scenario 33 illustrates inter-band non-contiguous carrier aggregation, in which component carriers that are non-adjacent in frequency and in multiple frequency bands are aggregated. For example, the third carrier aggregation scenario 33 depicts aggregation of component carriers f_{UL1} and f_{UL2} of a first frequency band BAND1 with component carrier f_{UL3} of a second frequency band BAND2.

FIG. 2C illustrates various examples of downlink carrier aggregation for the communication link of FIG. 2A. The examples depict various carrier aggregation scenarios 34-38 for different spectrum allocations of a first component carrier f_{DL1}, a second component carrier f_{DL2}, a third component carrier f_{DL3}, a fourth component carrier f_{DL1}, and a fifth component carrier f_{DL5}. Although FIG. 2C is illustrated in the context of aggregating five component carriers, carrier aggregation can be used to aggregate more or fewer carriers. Moreover, although illustrated in the context of downlink, the aggregation scenarios are also applicable to uplink.

The first carrier aggregation scenario 34 depicts aggregation of component carriers that are contiguous and located within the same frequency band. Additionally, the second carrier aggregation scenario 35 and the third carrier aggregation scenario 36 illustrates two examples of aggregation that are non-contiguous but located within the same frequency band. Furthermore, the fourth carrier aggregation scenario 37 and the fifth carrier aggregation scenario 38 illustrates two examples of aggregation in which component carriers that are non-adjacent in frequency and in multiple frequency bands are aggregated. As a number of aggregated component carriers increases, a complexity of possible carrier aggregation scenarios also increases.

With reference to FIGS. 2A-2C, the individual component carriers used in carrier aggregation can be of a variety of frequencies, including, for example, frequency carriers in the same band or in multiple bands. Additionally, carrier aggregation is applicable to implementations in which the individual component carriers are of about the same bandwidth as well as to implementations in which the individual component carriers have different bandwidths.

Certain communication networks allocate a particular user device with a primary component carrier (PCC) or anchor carrier for uplink and a PCC for downlink. Additionally, when the mobile device communicates using a single frequency carrier for uplink or downlink, the user device communicates using the PCC. To enhance bandwidth for uplink communications, the uplink PCC can be aggregated with one or more uplink secondary component carriers (SCCs). Additionally, to enhance bandwidth for downlink communications, the downlink PCC can be aggregated with one or more downlink SCCs.

In certain implementations, a communication network provides a network cell for each component carrier. Additionally, a primary cell can operate using a PCC, while a secondary cell can operate using a SCC. The primary and second cells may have different coverage areas, for instance, due to differences in frequencies of carriers and/or network environment.

License assisted access (LAA) refers to downlink carrier aggregation in which a licensed frequency carrier associated with a mobile operator is aggregated with a frequency carrier in unlicensed spectrum, such as WiFi. LAA employs a downlink PCC in the licensed spectrum that carries control and signaling information associated with the communication link, while unlicensed spectrum is aggregated for wider downlink bandwidth when available. LAA can operate with dynamic adjustment of secondary carriers to avoid WiFi users and/or to coexist with WiFi users. Enhanced license assisted access (eLAA) refers to an evolution of LAA that aggregates licensed and unlicensed spectrum for both downlink and uplink. Furthermore, NR-U can operate on top of LAA/eLAA over a 5 GHz band (5150 to 5925 MHz) and/or a 6 GHz band (5925 MHz to 7125 MHz).

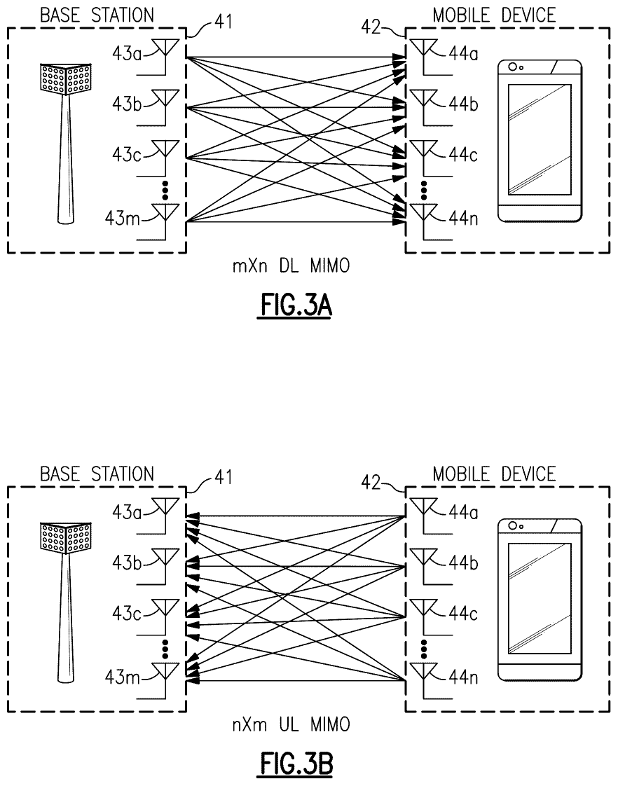

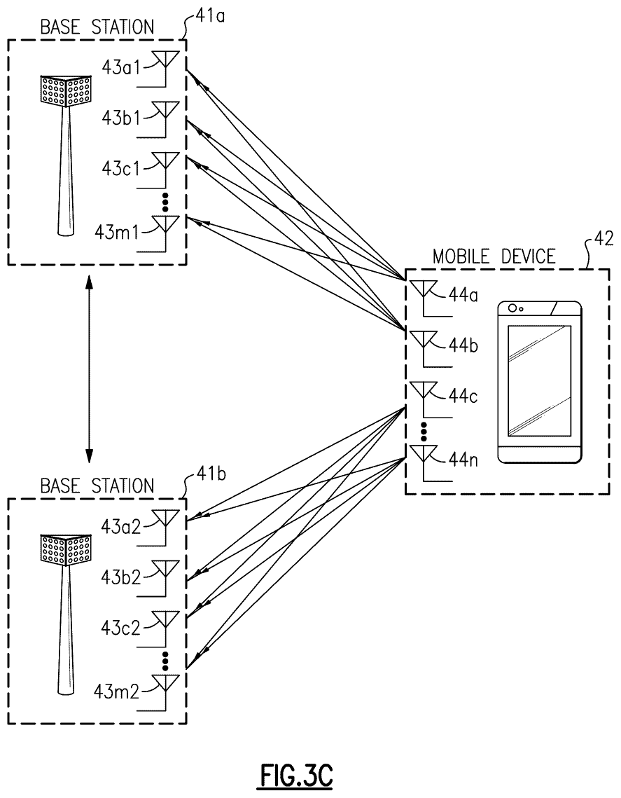

FIG. 3A is a schematic diagram of one example of a downlink channel using multi-input and multi-output (MIMO) communications. FIG. 3B is schematic diagram of one example of an uplink channel using MIMO communications.

MIMO communications use multiple antennas for simultaneously communicating multiple data streams over common frequency spectrum. In certain implementations, the data streams operate with different reference signals to enhance data reception at the receiver. MIMO communications benefit from higher SNR, improved coding, and/or reduced signal interference due to spatial multiplexing differences of the radio environment.

MIMO order refers to a number of separate data streams sent or received. For instance, MIMO order for downlink communications can be described by a number of transmit antennas of a base station and a number of receive antennas for UE, such as a mobile device. For example, two-by-two (2×2) DL MIMO refers to MIMO downlink communications using two base station antennas and two UE antennas. Additionally, four-by-four (4×4) DL MIMO refers to MIMO downlink communications using four base station antennas and four UE antennas.

In the example shown in FIG. 3A, downlink MIMO communications are provided by transmitting using M antennas 43a, 43b, 43c, . . . 43m of the base station 41 and receiving using N antennas 44a, 44b, 44c, . . . 44n of the mobile device 42. Accordingly, FIG. 3A illustrates an example of m×n DL MIMO.

Likewise, MIMO order for uplink communications can be described by a number of transmit antennas of UE, such as a mobile device, and a number of receive antennas of a base station. For example, 2×2 UL MIMO refers to MIMO uplink communications using two UE antennas and two base station antennas. Additionally, 4×4 UL MIMO refers to MIMO uplink communications using four UE antennas and four base station antennas.

In the example shown in FIG. 3B, uplink MIMO communications are provided by transmitting using N antennas 44a, 44b, 44c, . . . 44n of the mobile device 42 and receiving using M antennas 43a, 43b, 43c, . . . 43m of the base station 41. Accordingly, FIG. 3B illustrates an example of n×m UL MIMO.

By increasing the level or order of MIMO, bandwidth of an uplink channel and/or a downlink channel can be increased.

MIMO communications are applicable to communication links of a variety of types, such as FDD communication links and TDD communication links.

FIG. 3C is schematic diagram of another example of an uplink channel using MIMO communications. In the example shown in FIG. 3C, uplink MIMO communications are provided by transmitting using N antennas 44a, 44b, 44c, . . . 44n of the mobile device 42. Additional a first portion of the uplink transmissions are received using M antennas 43a1, 43b1, 43c1, . . . 43m1 of a first base station 41a, while a second portion of the uplink transmissions are received using M antennas 43a2, 43b2, 43c2, . . . 43m2 of a second base station 41b. Additionally, the first base station 41a and the second base station 41b communication with one another over wired, optical, and/or wireless links.

The MIMO scenario of FIG. 3C illustrates an example in which multiple base stations cooperate to facilitate MIMO communications.

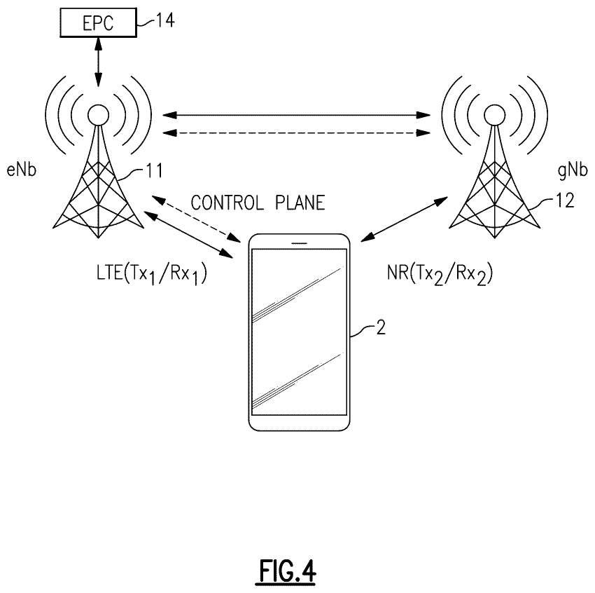

FIG. 4 is a schematic diagram of an example dual connectivity network topology. This architecture can leverage LTE legacy coverage to ensure continuity of service delivery and the progressive rollout of 5G and/or 6G cells. A UE 2 can simultaneously transmit dual uplink LTE and NR carrier. The UE 2 can transmit an uplink LTE carrier Tx1 to the eNB 11 while transmitting an uplink NR carrier Tx2 to the gNB 12 to implement dual connectivity. Any suitable combination of uplink carriers Tx1, Tx2 and/or downlink carriers Rx1, Rx2 can be concurrently transmitted via wireless links in the example network topology of FIG. 4. The eNB 11 can provide a connection with a core network, such as an Evolved Packet Core (EPC) 14. The gNB 12 can communicate with the core network via the eNB 11. Control plane data can be wireless communicated between the UE 2 and eNB 11. The eNB 11 can also communicate control plane data with the gNB 12. Control plane data can propagate along the paths of the dashed lines in FIG. 4. The solid lines in FIG. 4 are for data plane paths.

In the example dual connectivity topology of FIG. 4, any suitable combinations of standardized bands and radio access technologies (e.g., FDD, TDD, SUL, SDL) can be wirelessly transmitted and received. This can present technical challenges related to having multiple separate radios and bands functioning in the UE 2. With a TDD LTE anchor point, network operation may be synchronous, in which case the operating modes can be constrained to Tx1/Tx2 and Rx1/Rx2, or asynchronous which can involve Tx1/Tx2, Tx1/Rx2, Rx1/Tx2, Rx1/Rx2. When the LTE anchor is a frequency division duplex (FDD) carrier, the TDD/FDD inter-band operation can involve simultaneous Tx1/Rx1/Tx2 and Tx1/Rx1/Rx2.

As discussed above, EN-DC can involve both 4G, 5G, and/or 6G carriers being simultaneously transmitted from a UE. Transmitting multiple carriers of different radio access technologies (RATs) in a UE, such as a phone, typically involves two or more power amplifiers (PAs) being active at the same time.

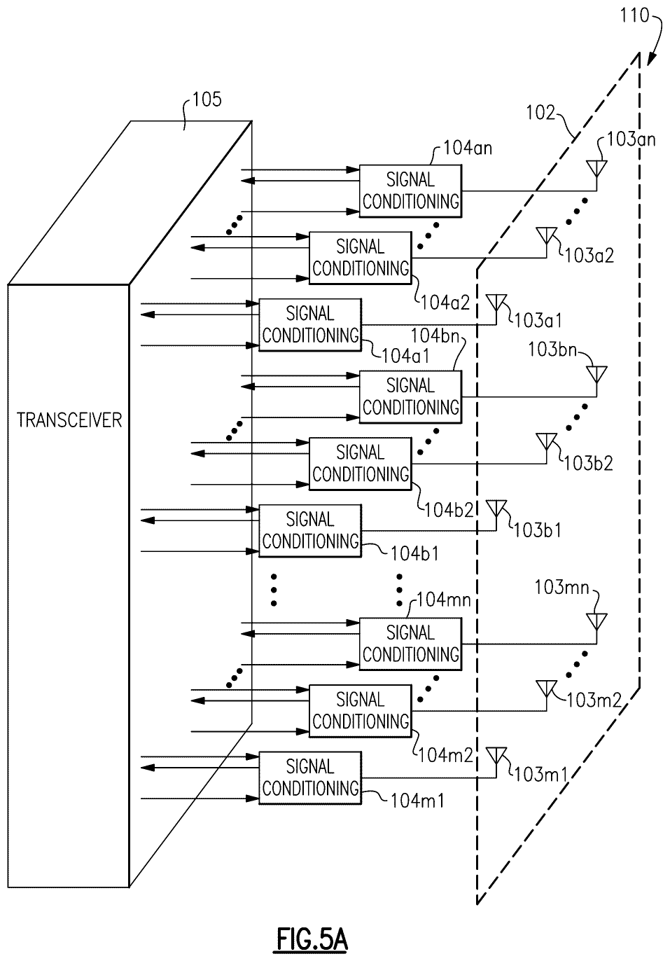

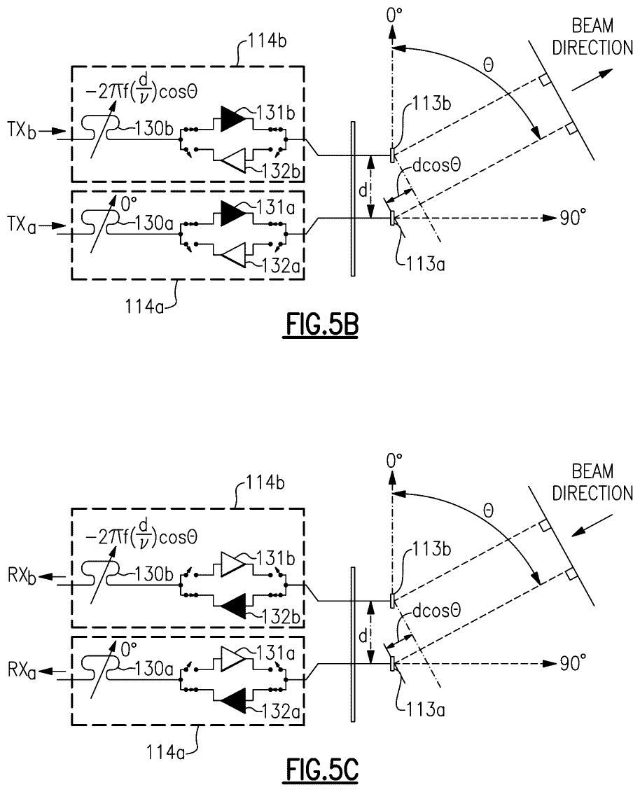

FIG. 5A is a schematic diagram of one example of a communication system 110 that operates with beamforming. The communication system 110 includes a transceiver 105, signal conditioning circuits 104a1, 104a2 . . . 104an, 104b1, 104b2 . . . 104bn, 104m1, 104m2 . . . 104mn, and an antenna array 102 that includes antenna elements 103a1, 103a2 . . . 103an, 103b1, 103b2 . . . 103bn, 103m1, 103m2 . . . 103mn.

Communications systems that communicate using millimeter wave carriers (for instance, 30 GHz to 300 GHz), centimeter wave carriers (for instance, 3 GHz to 30 GHz), and/or other frequency carriers can employ an antenna array to provide beam formation and directivity for transmission and/or reception of signals.

For example, in the illustrated embodiment, the communication system 110 includes an array 102 of m×n antenna elements, which are each controlled by a separate signal conditioning circuit, in this embodiment. As indicated by the ellipses, the communication system 110 can be implemented with any suitable number of antenna elements and signal conditioning circuits.

With respect to signal transmission, the signal conditioning circuits can provide transmit signals to the antenna array 102 such that signals radiated from the antenna elements combine using constructive and destructive interference to generate an aggregate transmit signal exhibiting beam-like qualities with more signal strength propagating in a given direction away from the antenna array 102.

In the context of signal reception, the signal conditioning circuits process the received signals (for instance, by separately controlling received signal phases) such that more signal energy is received when the signal is arriving at the antenna array 102 from a particular direction. Accordingly, the communication system 110 also provides directivity for reception of signals.

The relative concentration of signal energy into a transmit beam or a receive beam can be enhanced by increasing the size of the array. For example, with more signal energy focused into a transmit beam, the signal is able to propagate for a longer range while providing sufficient signal level for RF communications. For instance, a signal with a large proportion of signal energy focused into the transmit beam can exhibit high effective isotropic radiated power (EIRP).

In the illustrated embodiment, the transceiver 105 provides transmit signals to the signal conditioning circuits and processes signals received from the signal conditioning circuits. As shown in FIG. 5A, the transceiver 105 generates control signals for the signal conditioning circuits. The control signals can be used for a variety of functions, such as controlling the gain and phase of transmitted and/or received signals to control beamforming.

FIG. 5B is a schematic diagram of one example of beamforming to provide a transmit beam. FIG. 5B illustrates a portion of a communication system including a first signal conditioning circuit 114a, a second signal conditioning circuit 114b, a first antenna element 113a, and a second antenna element 113b.

Although illustrated as included two antenna elements and two signal conditioning circuits, a communication system can include additional antenna elements and/or signal conditioning circuits. For example, FIG. 5B illustrates one embodiment of a portion of the communication system 110 of FIG. 5A.

The first signal conditioning circuit 114a includes a first phase shifter 130a, a first power amplifier 131a, a first low noise amplifier (LNA) 132a, and switches for controlling selection of the power amplifier 131a or LNA 132a. Additionally, the second signal conditioning circuit 114b includes a second phase shifter 130b, a second power amplifier 131b, a second LNA 132b, and switches for controlling selection of the power amplifier 131b or LNA 132b.

Although one embodiment of signal conditioning circuits is shown, other implementations of signal conditioning circuits are possible. For instance, in one example, a signal conditioning circuit includes one or more band filters, duplexers, and/or other components.

In the illustrated embodiment, the first antenna element 113a and the second antenna element 113b are separated by a distance d. Additionally, FIG. 5B has been annotated with an angle Θ, which in this example has a value of about 90° when the transmit beam direction is substantially perpendicular to a plane of the antenna array and a value of about 0° when the transmit beam direction is substantially parallel to the plane of the antenna array.

By controlling the relative phase of the transmit signals provided to the antenna elements 113a, 113b, a desired transmit beam angle Θ can be achieved. For example, when the first phase shifter 130a has a reference value of 0°, the second phase shifter 130b can be controlled to provide a phase shift of about −2πf(d/ν)cos Θ radians, where f is the fundamental frequency of the transmit signal, d is the distance between the antenna elements, ν is the velocity of the radiated wave, and π is the mathematic constant pi.

In certain implementations, the distance d is implemented to be about ½λ, where λ is the wavelength of the fundamental component of the transmit signal. In such implementations, the second phase shifter 130b can be controlled to provide a phase shift of about −π cos Θ radians to achieve a transmit beam angle Θ.

Accordingly, the relative phase of the phase shifters 130a, 130b can be controlled to provide transmit beamforming. In certain implementations, a baseband processor and/or a transceiver (for example, the transceiver 105 of FIG. 5A) controls phase values of one or more phase shifters and gain values of one or more controllable amplifiers to control beamforming.

FIG. 5C is a schematic diagram of one example of beamforming to provide a receive beam. FIG. 5C is similar to FIG. 5B, except that FIG. 5C illustrates beamforming in the context of a receive beam rather than a transmit beam.

As shown in FIG. 5C, a relative phase difference between the first phase shifter 130a and the second phase shifter 130b can be selected to about equal to −2πf(d/ν)cos Θ radians to achieve a desired receive beam angle Θ. In implementations in which the distance d corresponds to about ½λ, the phase difference can be selected to about equal to −π cos Θ radians to achieve a receive beam angle Θ.

Although various equations for phase values to provide beamforming have been provided, other phase selection values are possible, such as phase values selected based on implementation of an antenna array, implementation of signal conditioning circuits, and/or a radio environment.

### Examples of Supplementary Uplink for Enabling High Power Class for FDD

Modern cellular networks are typically limited by uplink (UL) power from UE (for instance, about 0.5 W) as opposed to downlink (DL) power from the base station (for instance, in the range of 40-60 W).

To provide extended operation of UE at a cell edge, it is desirable to transmit from the UE with higher power to overcome pathloss challenges. For such scenarios, a cellular standard can specify one or more high power classes to enhance UE transmit power at cell edge or for other desired operating scenarios. Since lower frequency signals have lower pathloss, such transmissions at cell edge can also be transmitted at lower frequency using supplementary uplink (SUL).

For example, with respect to fifth generation (5G), certain 5G TDD frequency bands (for instance, n34, n39, n40, n41, n77, n78, or n79) can be operated with UL power class 2 (PC2) to provide +26 dBm at the antenna, which is 3 dB higher in-burst than the default power class 3 (PC3) providing +23 dBm. When a UE is operating using PC2 for a 5G TDD frequency band, the uplink (transmit) is duty-cycled ON and OFF to enable the downlink (receive) to fill complementary openings in the frame configuration. Due to the multiplexing by time slot, PC2 for the 5G TDD frequency band does not suffer from concurrency issues between transmit and receive.

PC2 for TDD frequency bands provides UE with improved coverage or range, such as enabling the UE to transmit at 20-40% more distance from the base station (gNodeB) due to the extra uplink power. Thus, PC2 for TDD frequency bands improves cell edge signal-to-noise ratio (SNR) and data rate performance. Moreover, PC2 for TDD frequency bands can reduce DC power consumption of the UE's radio as the uplink data rate increase can enable less ON time for the transmitter and a corresponding reduction in uplink current.

However, PC2 for FDD frequency bands is challenging due to a default of continuous operation of both transmit and receive concurrently. To mitigate concurrency issues, uplink can be duty-cycled to no more than 50% so that additional 3 dB power for PC2 in-burst will average to no more than +23 dBm, the same power supported continuously in FDD mode.

An FDD frequency band can include a transmit or uplink frequency range and a corresponding receive or downlink frequency range. In a front-end system of UE, transmit signals and receive signals for the FDD frequency band are handled by a duplexer.

When transmitting through such a duplexer for PC2, terrible degradations can occur for the paired FDD receive range due to higher transmit leakage, noise in the duplex gap, and/or receive band noise (RxBN) on the active receive channel. For example, PC2 can provide 3 dB higher power in burst and result in 5 dB to 20 dB of maximum receiver sensitivity degradation (MSD) that impairs the receive performance significantly. The uplink power is at maximum at cell edge when the receiver is close to the sensitivity level, and thus the UE's receiver is particularly susceptible to such degradations.

Techniques for SUL to enable high power class for FDD are disclosed. In certain embodiments, a mobile device for a cellular network includes a front-end system that includes a first duplexer for a first frequency band that operates using FDD and a second duplexer for a second frequency band that operates using FDD. Additionally, the mobile device provides high power class for FDD by transmitting a transmit signal over an uplink frequency range of the first frequency band and receiving a receive signal over a downlink frequency range of the second frequency band. The first frequency band and the second frequency band can have a large frequency offset, for instance, at least five times the channel bandwidth of the transmit signal.

Accordingly, rather than using the same frequency band to achieve high power class operation for FDD, two frequency bands of large frequency offset can be used. For instance, such a mobile device can achieve PC2 FDD operation by selecting transmit and receive frequency pairings associated with different frequency bands to eliminate the degradation of the closely spaced default paired receive range. Thus, a receive range having a large frequency offset is selected to better reject the transmit impairments and better preserve the receive performance of the use case.

Thus, rather than pairing a transmit range and a receive range of the same FDD frequency band (for instance, B28A transmit paired with B28A receive providing a 55 MHz duplex spacing and only 10 MHz duplex gap), the transmit range and the receive range are associated with two different FDD frequency bands that have a large gap.

As a first example, B28A transmit paired can be paired with B3 receive. In this example, B28A receive is not ON to eliminate the close in isolation related degradations that result in enormous MSD, and instead receive on another frequency band (for instance, in MB, etc.) that has the benefit of additional antenna-plexer filtering and rejection and large frequency offset to enable improved performance without any of the degradations associated with the higher power.

In another example, B5 and B1 is used as a band pairing. Although various examples of band pairings have been disclosed, other implementations are possible.

Thus, certain embodiments herein include front-end systems implemented to support frequency band pairings with a large frequency gap to support SUL for PC2 FDD. Thus, the close-adjacent transmit-to-receive isolation impairments that degrade receiver performance are eliminated.

In one aspect, the teachings herein can be applied to enable LB PC2 FDD by pairings with MB, HB, or UHB to large advantage. Such implementations are beneficial in a wide range of applications, including automotive where up to 4 LB antennas may be applied and specific absorption rate (SAR) limitations are not a consideration.

In certain embodiments, a duplexer for FDD is used, but while operating in PC2 FDD mode the receive range of the duplexer is not used. Thus, rather than receiving on the closely adjacent receive paired band, the receive range is far distant in offset frequency.

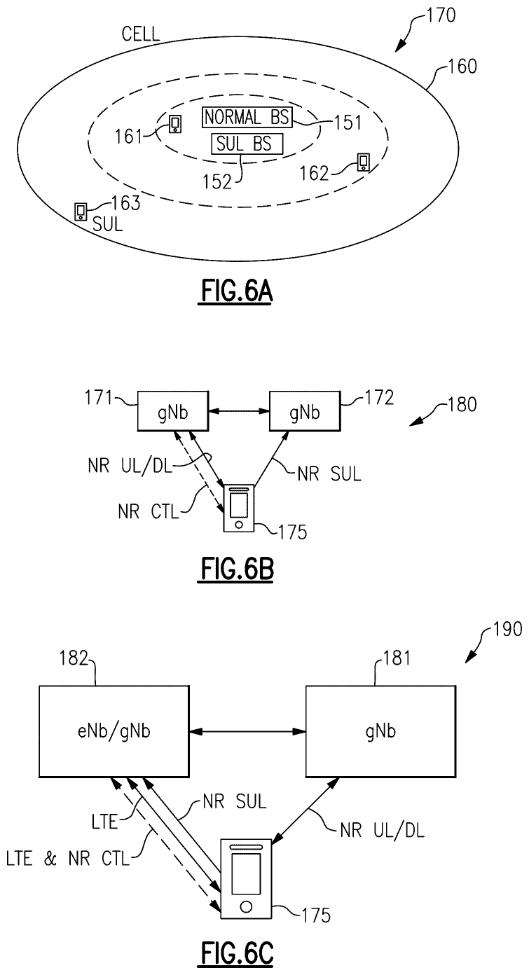

FIG. 6A is a schematic diagram of one embodiment of a communication network 170 using SUL. The communication network 170 includes a primary or normal base station 151, a SUL base station 152, and various mobile devices 161-163. The primary base station 151 and the SUL base station 152 serves a land area or cell 160, in this example. Additionally, the mobile devices 161-163 are in different locations of the cell 160 associated with different distances to the base stations.

Although one example of a communication network is shown, other configurations are possible, including, for example, communication networks with other numbers and/or types of user devices and/or base stations.

Certain communication systems dynamically control uplink signaling (for instance, modulation, power, and/or frequency of transmissions) based on a quality of a communication link.

For example, it can be difficult to receive a signal with accuracy when SNR is relatively low. Thus, as the symbols in a constellation increase, it can become increasing more difficult to determine which symbol has been communicated. Accordingly, certain communication systems dynamical control modulation based on SNR.

The transmit power of UE transmissions can also be controlled based on the quality of the communication link. For example, transmissions associated with a higher power class can have higher SNR and improved communications quality between the UE and base station.

A UE can also change the frequency of transmission based on the quality of the communication link. For example, since path losses decrease with frequency, UE may be able to transmit at a greater distance using a lower frequency.

With reference to FIG. 6A, the mobile devices 161-163 are at varying distances from the base stations. For example, the first mobile device 161 and the second mobile device 162 are relatively close to the base stations, while the third mobile device 163 is near the cell edge.

To improve performance, the mobile devices 161-163 communicate with different base stations of the same cell 160. For example, the first mobile device 161 and the second mobile device 162 can communicate with the primary base station 151, while the third mobile device 163 can operate with SUL and communicate with the SUL base station 152. The SUL transmissions from the third mobile device 163 can be associated with higher transmit power and/or lower frequency as compared to UL transmissions form the first mobile device 161 and the second mobile device 162. In one example, the third mobile device 163 can use PC2 in LB while the first mobile device 161 and the second mobile device 162 can use PC3 in HB.

FIG. 6B is a schematic diagram of another embodiment of a communication network 180 using SUL. The communication network 180 includes a primary gNodeB (gNb) 163, a SUL gNb 164, and a mobile device or UE 175.

The mobile device 175 communicates NR UL/DL signals and NR control (CTL) signals to the primary gNb 163 during typical operating conditions. Such communications can be over a desired 5G frequency band (for instance, MB, HB, or UHB). However, in certain signaling scenarios, such as near cell edge, the mobile device 175 communicates NR SUL signals to the SUL gNb 172 over a lower frequency, for instance, in LB.

FIG. 6C is a schematic diagram of another embodiment of a communication network 190 using SUL. The communication network 190 includes a primary gNb 181, an eNb/gNb 182 used for SUL, and a mobile device 175.

During normal operation, the mobile device 185 operates with EN-DC to communicate NR UL/DL signals to the primary gNb 181 while also communicating LTE signals and LTE/NR control to the eNb/gNb 182. However, in certain signaling scenarios, such as near cell edge, the mobile device 181 communicates NR SUL signals to the eNb/gNb 182 over a lower frequency, for instance, in LB.

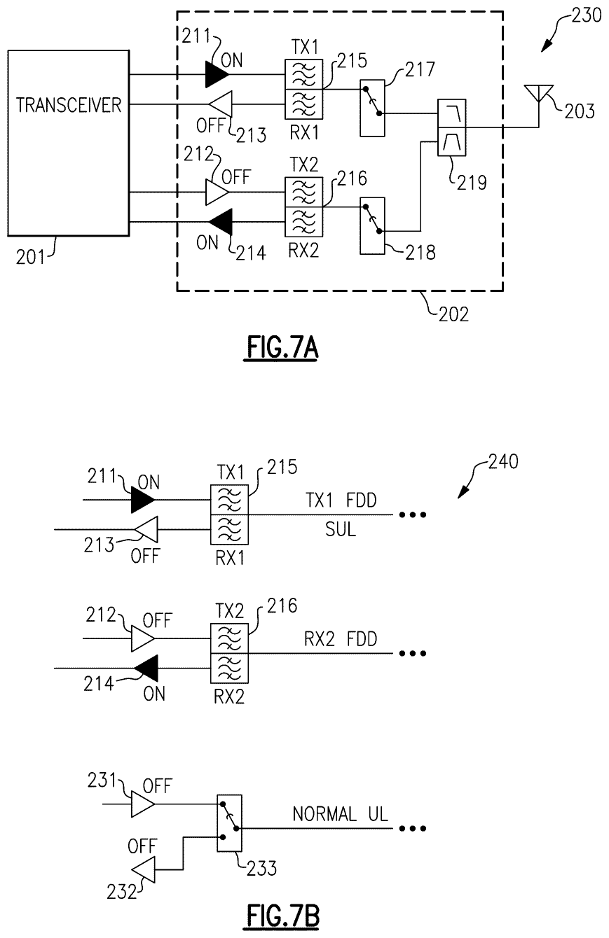

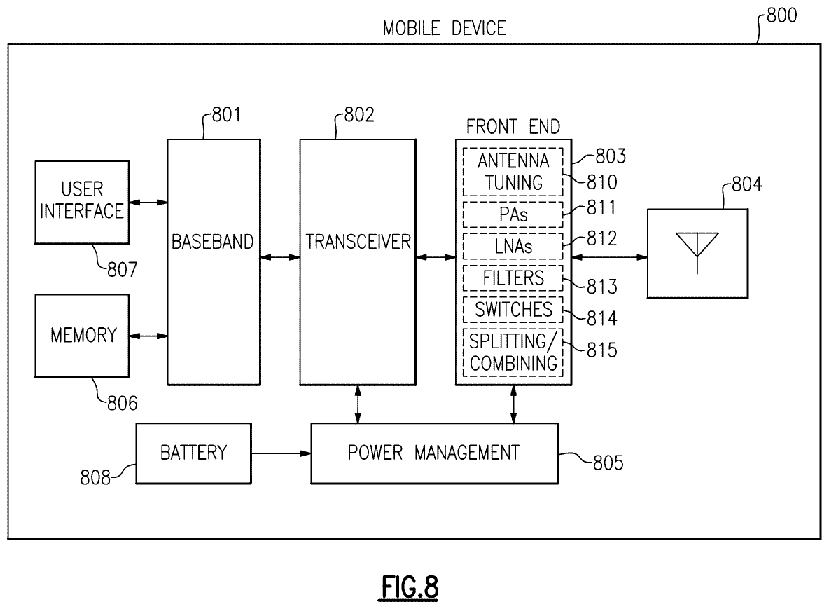

FIG. 7A is a schematic diagram of one embodiment of a mobile device 230 providing SUL to support high power class for FDD. The mobile device 230 includes a transceiver 201, a front-end system 202, and an antenna 203.

Although one embodiment of a mobile device for supporting high power class for FDD is shown, a mobile device can be implemented in other ways. For example, other implementations of front-end systems, transceivers, and/or antenna arrangements can be used. Furthermore, the mobile device 230 can include additional components, such as those described further below with reference to FIG. 8. The mobile device 230 can represent various types of UE including, but not limited to, mobile phones, tablets, laptops, IoT devices, wearable electronics, wireless-connected vehicles, and/or a wide variety of other communication devices.

In the illustrated embodiment, the front-end system 202 includes a first power amplifier 211 for a first FDD frequency band, a first low noise amplifier (LNA) 213 for the first FDD frequency band, a first duplexer 215 for the first FDD frequency band, a first band selection switch 217, a second power amplifier 212 for a second FDD frequency band, a second LNA 214 for the second FDD frequency band, a second duplexer 216 for the second FDD frequency band, a second band selection switch 218, and an antenna-plexer 219. The first FDD frequency band has a transmit frequency range TX1 and a receive frequency range RX1, while the second FDD frequency band has a transmit frequency range TX2 and a receive frequency range RX2.

The mobile device 230 operates to provide SUL for FDD UL to enable high power class (for instance, PC2) for FDD. As shown in FIG. 7A, the first power amplifier 211 coupled to a transmit section of the first duplexer 215, the first LNA 213 is coupled to a receive section of the first duplexer 215, a second power amplifier 212 coupled to a transmit section of the second duplexer 216, and the second LNA 214 is coupled to a receive section of the second duplexer 216. Additionally, the first power amplifier 211 and the second LNA 214 are turned on, while the second power amplifier 212 and the first LNA 213 are turned off.

Thus, rather than using the same duplexer for both transmit and receive, the mobile device 230 uses the transmit frequency range TX1 of the first duplexer 215 and the receive frequency range RX2 of the second duplexer 216. The first FDD frequency band and the second FDD frequency band can have a large frequency offset, for instance, at least five times the channel bandwidth of the transmit signal.

Accordingly, rather than using the same frequency band to achieve high power class operation, two frequency bands of large frequency offset can be used. For instance, the mobile device 230 can achieve PC2 FDD operation by selecting transmit and receive frequency pairings associated with different frequency bands to eliminate the degradation of the closely spaced default paired receive range.

Thus, rather than pairing a transmit range and a receive range of the same FDD frequency band (for instance, using TX1 and RX1 in this example), the transmit range and the receive range are associated with two different FDD frequency bands that have a large gap.

Examples of band pairings include, but are not limited to, B28 and B3 or B5 and B1. In some implementations, the first FDD frequency band is in LB, while the second FDD frequency band is in MB, HB, or UHB. Although various examples of band pairings have been disclosed, other implementations are possible.

FIG. 7B is a schematic diagram of another embodiment of a front-end system 240 for a mobile device providing SUL to support high power class for FDD. The front-end system includes a first power amplifier 211 for a first FDD frequency band, a first LNA 213 for the first FDD frequency band, a first duplexer for the first FDD frequency band, a second power amplifier 212 for the second FDD frequency band, a second LNA 214 for the second FDD frequency band, a third power amplifier 231 for a TDD frequency band, a third LNA 232 for the TDD frequency band, and a transmit/receive (T/R) switch 233 for the TDD frequency band. In certain implementations, at least the first FDD frequency band is lower in frequency than the TDD frequency band.

In the illustrated embodiment, the third power amplifier 231 (associated with primary or normal UL transmissions) has been turned off, for instance, due to the mobile device being near cell edge. Additionally, SUL is provided by turning on the first power amplifier 211 to transmit TX1 while also turning off the first LNA 213. Further, the fourth LNA 214 is turned on to receive over RX2. Thus, rather than using TX1/RX1 for SUL, the illustrated embodiment uses TX1/RX2.

FIG. 8 is a schematic diagram of another embodiment of a mobile device 800. The mobile device 800 includes a baseband system 801, a transceiver 802, a front-end system 803, antennas 804, a power management system 805, a memory 806, a user interface 807, and a battery 808.

The mobile device 800 can be used communicate using a wide variety of communications technologies, including, but not limited to, 2G, 3G, 4G (including LTE, LTE-Advanced, and LTE-Advanced Pro), 5G NR, 6G, WLAN (for instance, WiFi), WPAN (for instance, Bluetooth and ZigBee), WMAN (for instance, WiMax), and/or GPS technologies.

The transceiver 802 generates RF signals for transmission and processes incoming RF signals received from the antennas 804. It will be understood that various functionalities associated with the transmission and receiving of RF signals can be achieved by one or more components that are collectively represented in FIG. 8 as the transceiver 802. In one example, separate components (for instance, separate circuits or dies) can be provided for handling certain types of RF signals. Such separate transceiver circuits or dies can receive separate RF split signals from the front-end systems implemented in accordance with the teachings herein.

The front-end system 803 aids in conditioning signals transmitted to and/or received from the antennas 804. In the illustrated embodiment, the front-end system 803 includes antenna tuning circuitry 810, power amplifiers (PAS) 811, low noise amplifiers (LNAs) 812, filters 813, switches 814, and signal splitting/combining circuitry 815.

With continuing reference to FIG. 8, the front-end system 803 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

In certain implementations, the mobile device 800 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous and can include carriers separated in frequency within a common band or in different bands.

The antennas 804 can include antennas used for a wide variety of types of communications. For example, the antennas 804 can include antennas for transmitting and/or receiving signals associated with a wide variety of frequencies and communications standards. At least one of the antennas 804 is implemented with a differential interface in accordance with the teachings herein.

In certain implementations, the antennas 804 support MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

The mobile device 800 can operate with beamforming in certain implementations. For example, the front-end system 803 can include amplifiers having controllable gain and phase shifters having controllable phase to provide beam formation and directivity for transmission and/or reception of signals using the antennas 804. For example, in the context of signal transmission, the amplitude and phases of the transmit signals provided to the antennas 804 are controlled such that radiated signals from the antennas 804 combine using constructive and destructive interference to generate an aggregate transmit signal exhibiting beam-like qualities with more signal strength propagating in a given direction. In the context of signal reception, the amplitude and phases are controlled such that more signal energy is received when the signal is arriving to the antennas 804 from a particular direction. In certain implementations, the antennas 804 include one or more arrays of antenna elements to enhance beamforming.

The baseband system 801 is coupled to the user interface 807 to facilitate processing of various user input and output (I/O), such as voice and data. The baseband system 801 provides the transceiver 802 with digital representations of transmit signals, which the transceiver 802 processes to generate RF signals for transmission. The baseband system 801 also processes digital representations of received signals provided by the transceiver 802. As shown in FIG. 8, the baseband system 801 is coupled to the memory 806 of facilitate operation of the mobile device 800.

The memory 806 can be used for a wide variety of purposes, such as storing data and/or instructions to facilitate the operation of the mobile device 800 and/or to provide storage of user information.

The power management system 805 provides a number of power management functions of the mobile device 800. In certain implementations, the power management system 805 includes a PA supply control circuit that controls the supply voltages of the power amplifiers 811. For example, the power management system 805 can be configured to change the supply voltage(s) provided to one or more of the power amplifiers 811 to improve efficiency, such as power added efficiency (PAE).

As shown in FIG. 8, the power management system 805 receives a battery voltage from the battery 808. The battery 808 can be any suitable battery for use in the mobile device 800, including, for example, a lithium-ion battery.

### Applications

Some of the embodiments described above have provided examples in connection with mobile devices. However, the principles and advantages of the embodiments can be used for a wide range of RF communication systems. Examples of such RF communication systems include, but are not limited to, mobile phones, tablets, base stations, network access points, customer-premises equipment (CPE), laptops, and wearable electronics.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “may,” “could,” “might,” “can,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A mobile device comprising:
an antenna; and
a front-end system coupled to the antenna, the front-end system including a first duplexer for a first frequency band that operates using frequency division duplexing, a second duplexer for a second frequency band that operates using frequency division duplexing, a first power amplifier coupled to a transmit section of the first duplexer, a first low noise amplifier coupled to a receive section of the first duplexer, and a second low noise amplifier coupled to a receive section of the second duplexer, the mobile device providing supplementary uplink for frequency division duplexing by transmitting a transmit signal from the first power amplifier through the first duplexer and receiving a receive signal at the second low noise amplifier through the second duplexer.

2. The mobile device of claim 1 wherein the first low noise amplifier is turned off when the mobile device is providing supplementary uplink.

3. The mobile device of claim 1 wherein the first frequency band is in a low band frequency range.

4. The mobile device of claim 1 wherein the first frequency band is offset in frequency from the second frequency band by at least five times a channel bandwidth of the transmit signal.

5. The mobile device of claim 1 wherein the front-end system further includes a second power amplifier coupled to a transmit section of the second duplexer.

6. The mobile device of claim 5 wherein the second power amplifier is turned off when the mobile device is providing supplementary uplink.

7. The mobile device of claim 5 wherein the front-end system further includes a transmit/receive switch, a third power amplifier having an output coupled to the transmit/receive switch, and a third low noise amplifier having an input coupled to the transmit/receive switch, the third power amplifier active for normal uplink and turned off for supplementary uplink.

8. The mobile device of claim 7 wherein the mobile device transitions from normal uplink to supplementary uplink at a cell edge.

9. The mobile device of claim 8 wherein the mobile device transitions from power class 3 to power class 2 at the cell edge, the transmit signal being associated with power class 2.

10. A method of supplemental uplink in a mobile device, the method comprising:
providing duplexing for a first frequency band operating with frequency division duplexing using a first duplexer of a front-end system, the first duplexer having a transmit section coupled to a first power amplifier of the front-end system and a receive section coupled to a first low noise amplifier of the front-end system;
providing duplexing for a second frequency band operating with frequency division duplexing using a second duplexer of the front-end system, the second duplexer having a receive section coupled to a second low noise amplifier of the front-end system; and
providing supplementary uplink for frequency division duplexing by transmitting a transmit signal from the first power amplifier through the first duplexer and receiving a receive signal at the second low noise amplifier through the second duplexer.

11. The method of claim 10 further comprising turning off the first low noise amplifier when providing supplementary uplink.

12. A front-end system for a mobile device, the front-end system comprising:
a first duplexer for a first frequency band that operates using frequency division duplexing;
a second duplexer for a second frequency band that operates using frequency division duplexing;
a first power amplifier coupled to a transmit section of the first duplexer;
a first low noise amplifier coupled to a receive section of the first duplexer; and
a second low noise amplifier coupled to a receive section of the second duplexer, the front-end system providing supplementary uplink for frequency division duplexing by transmitting a transmit signal from the first power amplifier through the first duplexer and receiving a receive signal at the second low noise amplifier through the second duplexer.

13. The front-end system of claim 12 wherein the first low noise amplifier is turned off during supplementary uplink.

14. The front-end system of claim 12 wherein the first frequency band is in a low band frequency range.

15. The front-end system of claim 14 wherein the first frequency band is offset in frequency from the second frequency band by at least five times a channel bandwidth of the transmit signal.

16. The front-end system of claim 12 further comprising a second power amplifier coupled to a transmit section of the second duplexer.

17. The front-end system of claim 16 wherein the second power amplifier is turned off when the mobile device is providing supplementary uplink.

18. The front-end system of claim 16 further comprising a transmit/receive switch, a third power amplifier having an output coupled to the transmit/receive switch, and a third low noise amplifier having an input coupled to the transmit/receive switch, the third power amplifier active for normal uplink and turned off for supplementary uplink.

19. The front-end system of claim 18 wherein the front-end system transitions from normal uplink to supplementary uplink at a cell edge.

20. The front-end system of claim 19 wherein the front-end system transitions from power class 3 to power class 2 at the cell edge, the transmit signal being associated with power class 2.
